(19) United States
(12) Patent Application Publication
(10) Pub. No.: US 2003/0151480 A1
(43) Pub. Date: Aug. 14, 2003

(54) Process for fabricating an ADSL relay array

(75) Inventor: Bruce Francis Orr, Balgowlah (AU)

Correspondence Address: SUGHRUE MION, PLLC, 2100 Pennsylvania Avenue, NW, Washington, DC, 20037-3213, US

(73) Assignee: ALCATEL

(21) Appl. No.: 10/340,643

(22) Filed: Jan. 13, 2003

(30) Foreign Application Priority Data
Jan. 23, 2002 (EP) 02 360 040.6

(51) Int. Cl. H01H 51/22

(52) U.S. Cl. 335/78

(57) ABSTRACT

A method of fabricating electro-magnetic relays and arrays of relays using existing and adapted PCB fabrication techniques, in which the activation coils are incorporated into the layers of a multi-layer PCB and the magnetic circuit of the relay is formed partly on the surface of the PCB using, eg, electroplating techniques, and partly in one or more through-holes using plated through holes, the plated through hole plating being extended to form a support for the movable relay contact which is formed on a removable release layer.

### BACKGROUND OF THE INVENTION

The invention is based on a priority application EP 02 360 040.6 which is hereby incorporated by reference.

This invention relates to a method of fabricating miniaturized relays and arrays of such relays. In particular, the invention relates to the fabrication of relay arrays using existing and modified PCB fabrication techniques.

One application for such an array is in the telecommunications field, particularly in the light of the demand for increased bandwidth transmission over subscriber copper lines. Techniques such as DSL utilize the subscriber copper to transmit broadband signals, up to several MHz, over the copper lines. There are several reasons which require the capability to switch the copper lines, such as the connection of new subscriber lines to the service, or connection of existing lines to an ADSL service. Conventional relays and solid state line relays are typically not sufficiently space/cost effective to fabricate line switching arrays.

There have been several developments in the MEMS (Micro-Electro-Mechanical Systems) field using, eg, Si based devices, to fabricate individual relays, and some attempts have been made to produce relay arrays.

U.S. Pat. No. 6,094,116 describes an electromechanical micro-relay using magnetic actuation and electrostatic latching. In the arrangement described in this patent the relay circuit is formed on the surface of a substrate. Because of the small open contact gaps in this design it is not well suited to switching telephone lines where voltages of up to 400V may be present. Also the design does not provide any solution for efficient arraying of relays. It may also be noted that conventional MEMS fabrication techniques can be quite costly, particularly where large chip sizes are involved (as required for switching arrays). The present invention addresses these limitations by providing a cost effective solution for high voltage switching arrays.

U.S. Pat. No. 6,078,233 discloses a miniature relay composed of individual components and an array in which some components, such as the armature, are fabricated on common sheets of material for assembly in relation to other components fabricated individually or in relation to another carrier substrate.

M. Ruan & J Shen “Latching Micro magnetic Relays with Multistrip Permalloy Cantilevers” IEEE 0-7803-4/01 discloses a latching relay fabricated on a surface of a substrate and associated with a permanent magnet. The relay has an open magnetic path and utilizes the alignment of the relay armature having a high aspect ratio with a permanent magnetic field to achieve latching. The relay is fabricated on a Si substrate using conventional MEMS techniques. The paper does not describe the fabrication of an array of relays.

H. Hosaka & H. Kuwano “Design & Fabrication of Miniature Relay Matrix & Investigation of Electromechanical Interference in Multi-Actuator Systems” IEEE Workshop on Micro-Electro-mechanical Systems paper 1994, Osio Jp 25-28 January 94. This paper describes a relay array utilizing discrete components such as magnet coils. Latching is achieved by affixing a permanent magnet to the armature spring.

### SUMMARY OF THE INVENTION

This invention provides a method of fabricating a miniaturized relay using conventional and adapted PCB fabrication processes. The process is suitable for the fabrication of an array of relays.

The invention proposes a method of fabricating a relay integral with a substrate, the relay including a magnetic path, one or more activating current paths, and a switched path including the relay contacts, the method including the steps of:

forming the activating current path or paths on or within the substrate;

forming at least a first magnetic through link in a via or through hole in the substrate from a first surface thereof and proximate to the activating current path or paths so that the first magnetic link is within the influence of magnetic flux from the current paths;

forming a first contact having both ferromagnetic characteristics and electrical conductivity on or near a first surface of the substrate;

forming a second contact having both ferro-magnetic characteristics and electrical conductivity near the surface of the substrate, at least the second contact being movable relative to the first contact to selectively make or break electrical contact;

the first contact being in magnetic association with the first magnetic through link.

According to a preferred method the relay having an activating current path and a magnetic path is fabricated on a substrate by providing one or more current paths embedded in, or on at least one surface of the substrate, and having at least a first part of the magnetic path formed in a via or through hole in the substrate, an armature forming part of the magnetic path being formed adjacent a first surface of the substrate and in working relationship with a contact on the first surface. In the preferred embodiment, the magnetic circuit is also conductive, so that the electrical and magnetic paths can be integrated. Alternatively, electrically conductive layers may be laminated onto the armature and contact pad to improve electrical performance.

Preferably, signal paths connected to the contact and armature are formed on the first surface. However, they may be formed in other available positions such as in an embedded layer or on the second surface.

Preferably, the magnetic path is a loop with two vias/through holes, the contact gap being a variable air gap in the magnetic path. In a further embodiment, a permanent magnet is provided in or near the magnetic path.

In a particular embodiment, the magnetic path includes a permanent air gap.

In another embodiment, a permanent magnet bridges the permanent air gap.

Preferably the poles of the permanent magnet are aligned across the permanent air gap.

The invention also includes an array of such relays.

In a preferred embodiment of the array, the activating current paths of several relays are common, there being at least two separate activating current paths activating each relay. Preferably the relays of the array and the activating current paths are aligned in two directions to facilitate addressing of a relay at an intersection of two or more activating current paths.

In a further embodiment, the contact pad is electrically isolated from the armature by a permanent air gap in the magnetic circuit.

There are a number of ways the moving contact can be attached to the substrate. The contact may be formed at the end of a cantilever. Alternatively the armature may be suspended between a pair of supports via a torsion support. Alternatively, the contact may be supported by preferably three or more flat spiral spring arrangements.

### BRIEF DESCRIPTION OF THE DRAWINGS

The invention will be described with reference to the accompanying drawings in which:

FIG. 1 is illustrative of a section through a relay fabricated by a method according to an embodiment of the invention,

FIG. 2 is an exploded view illustrating key elements of a relay according to an embodiment of the invention,

FIG. 3 illustrates the sacrificial layer according to an embodiment of the invention,

FIG. 4 illustrates stages in a fabrication process according to an embodiment of the invention,

FIG. 5 illustrates the electrical configuration of an array of relays fabricated according to a process embodying the invention,

FIG. 6 illustrates the layout of an array of relays according to an embodiment of the invention,

FIG. 7 illustrates the detail of a plated-through hole,

FIG. 8 shows examples of the layer configurations of the multi-layer PCB,

FIG. 9 illustrates a pre-fabricated, angled armature embossed on a release layer and

FIG. 10 shows a method of encapsulating a PCB containing an array of relays according to an embodiment of the invention.

### DETAILED DESCRIPTION OF THE EMBODIMENTS

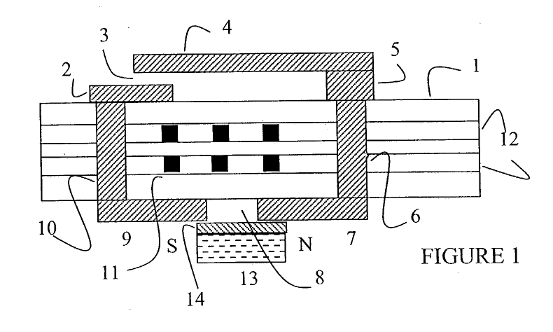

FIG. 1 shows a section through a relay made according to a process embodying the invention. A substrate 1, in this case a multi-layer PCB 12, carries a magnetic circuit, 2-10. The magnetic circuit includes:

2—a contact applied to the top of the substrate, 1;

3—the relay contact gap forming a variable air gap between 2 and armature 4;

4—the relay armature, in this case a flexible cantilever mounted on post 5;

5—the armature support post connected to 6;

6—a first via (through hole) filled with magnetic material;

7—a first magnetic link on the second surface of the substrate extending from 6 to gap 8;

8—a permanent air gap;

9—a second magnetic link on the second surface of the substrate between the gap 8 and via 10;

10—a second via filled with magnetic material connecting the contact pad 2 to the second magnetic link.

There are one or more conductive activation paths, 11, in one or more layers, 12, embedded in the substrate 1. A current of sufficient amplitude passing through these conductive paths 11 will cause the armature 4 to be attracted to the contact pad 2.

A permanent magnet may be placed across the air gap, 8, to form a latching mechanism. When there is a latching magnet, 13, in place, the current must be passed through the activation paths in the reverse sense to release the relay after it has been latched. When an array of such relays is formed, having, eg, rows and columns of individual relays, the air-gaps may be aligned, and strip magnets having alternate N and S poles arranged in strips aligned with the air-gaps can be used to provide a readily implemented latching arrangement for the relay array.

The strip magnets may be formed, eg, of flexible magnet material, familiar as “fridge” magnets.

Optionally, an insulating spacer layer, 14, may be interposed between the magnet film and the substrate. This ensures the magnet does not provide a current path between the two relay contacts.

A further development of this feature uses a soft magnetic layer in parallel with the strip magnet sheet. This is because permanent magnets have high reluctance, so the inclusion of a parallel soft magnetic material lowers the reluctance. Preferably, a soft magnet sheet is incorporated between the magnet sheet 13 and the insulation sheet 14.

The magnet sheet and the substrate are preferably provided with registration points to facilitate alignment of the magnet strips and the air-gaps in the relay magnetic loops. In a further embodiment, the magnet sheets may have a profile, eg, to include ridges which align with the air-gaps.

While it is preferable that the entire magnetic path, apart from the air gaps, is made of the same material and this material has both magnetic and electrical conduction characteristics, it is not essential that all parts of the magnetic path are made of the same material and have both electrical conductivity as well as magnetic characteristics. A suitable material which exhibits both ferro-magnetic characteristics and electrical conductivity is nickel. For all or part of the magnetic path, materials having improved magnetic characteristics, such as Permalloy, an alloy of Ni and Fe, may be used where improved magnetic characteristics are required.

It is important that the contact surfaces of the contact pad and the armature are conductive and corrosion, wear resistant, and this may be enhanced by coating these surfaces with a material having high conductivity, eg, silver, gold, palladium etc. The contact surfaces may also be alloys or layered eg a silver underlayer with gold flash coating to achieve the desired contact properties. Such contact structures are well known in conventional relays and most contact types used in conventional relays can be adapted to the present invention.

The primary requirement of the armature is that it is resilient. In one embodiment, the armature is a part of the magnetic circuit, while in another embodiment, the armature need not be magnetic, but it must then carry a magnetic bridge at its free end. The armature also needs to provide electrical conductivity either directly or by use of conductive tracks applied thereto. The conductive parts of the contact pad and the armature are connected to conductive tracks, not shown in the figures, so an electrical circuit can be opened and closed via the relay contacts.

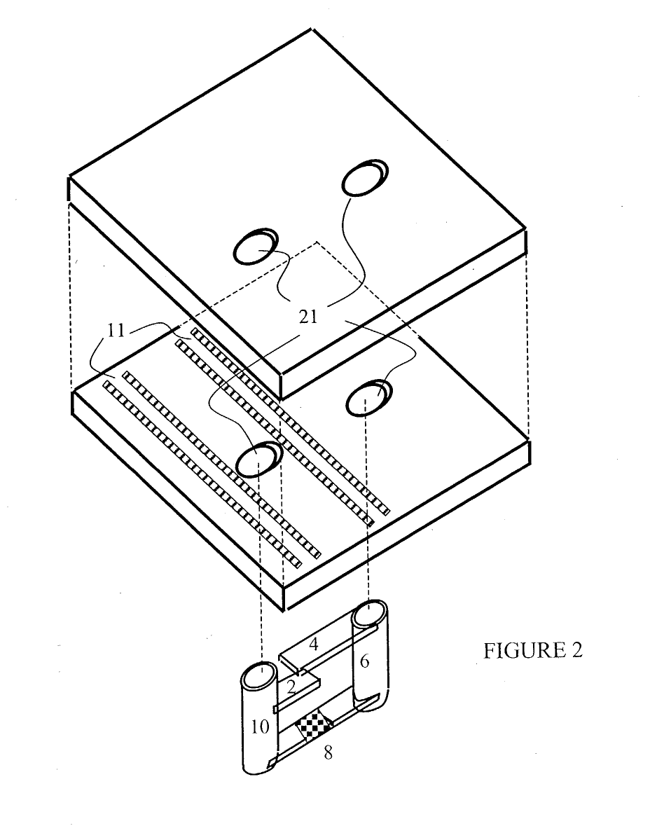

FIG. 2 is an exploded perspective view illustrating an arrangement of the through holes and conductive activation paths 11 and the magnetic circuit 2, 4, 6, 8, 10. The substrate is formed of a multi-layer PCB with one or more conductive activation current paths printed on one or more of the layers. In practice there may be several layers, but only two are shown in FIG. 2 for simplicity. In FIG. 2, like objects are labelled as in FIG. 1. The conductive tracks, 11, are shown on the lower layer of the substrate, and the through holes, 21, through which the magnetic path passes are visible. The magnetic circuit, 2, 4, 6, 8, 10 is formed using standard and adapted PCB fabrication techniques as described herein. The holes 21 may be formed and plated through using known PCB assembly processes during the fabrication of the PCB.

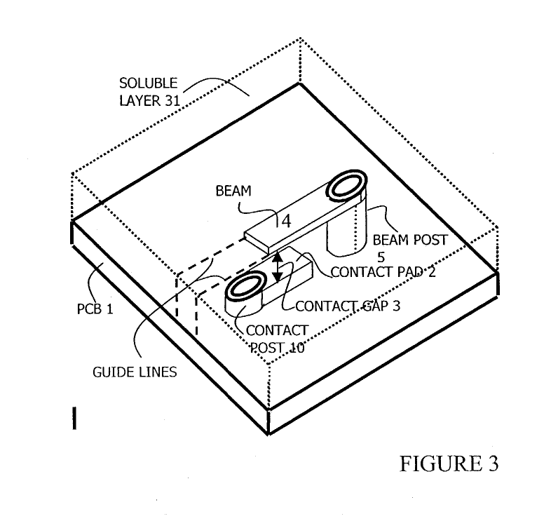

FIG. 3 shows a top perspective view of the soluble layer, contacts, beam and beam post.

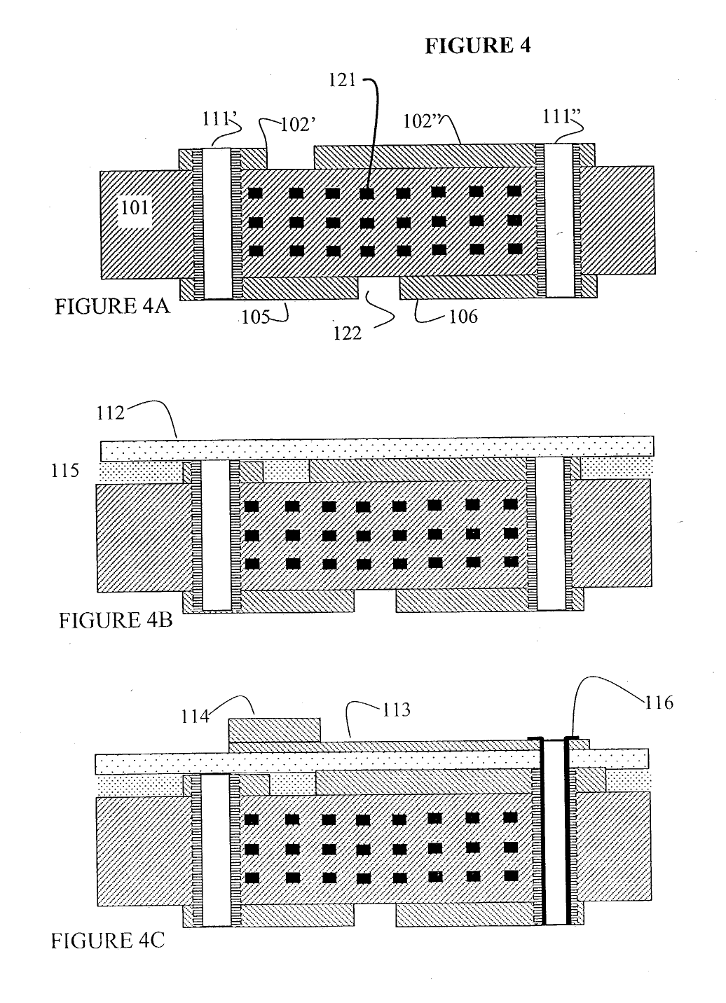

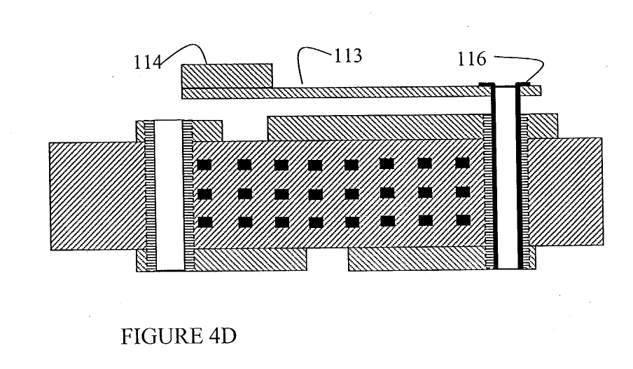

FIG. 4 shows a section through a relay according to an embodiment of the invention at various stages during the fabrication process.

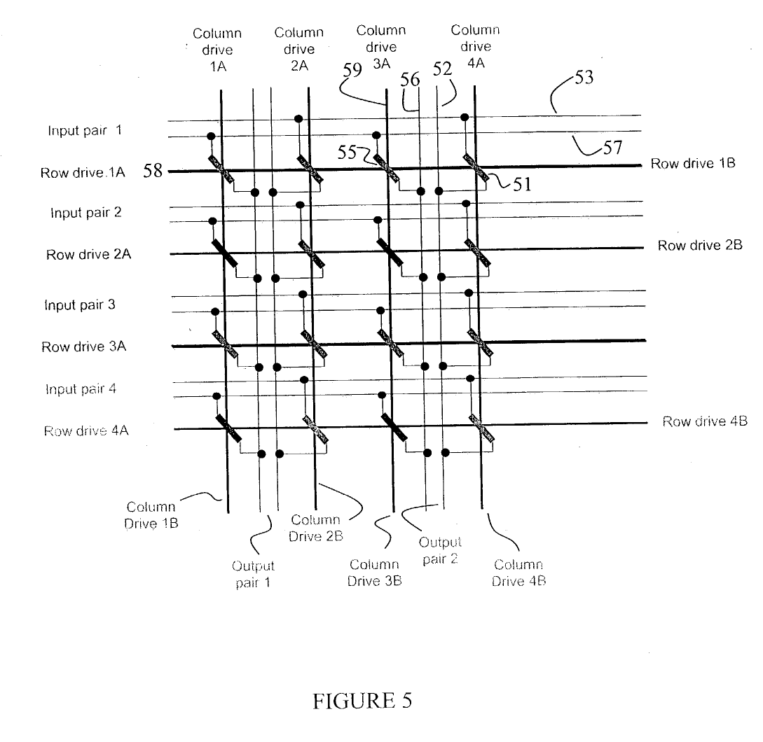

In FIG. 4A a substrate 101 is fabricated from a multi-layer PCB embedded in which are one or more conductor tracks 121. These tracks are formed using known fabrication techniques. The tracks on different layers may be parallel, but according to a preferred embodiment, the tracks on different layers may form an intersecting pattern of rows and columns (see FIGS. 5 & 6). Such a pattern simplifies the application of control currents in an array of relays where a row and column addressing system is utilized, as in the preferred embodiment. According to this embodiment, the relays of an array are located at the intersections of the rows and columns so that both the now and column conductors pass through the relay's magnetic path. The relay at an intersection can be activated by energizing both the row and column conductors passing through the intersection in an additive manner with a current in each conductor being less than the trip current, but the sum of the two currents exceeding the trip current. A greater degree of discrimination may be obtained by including, e.g., one or more diagonal intersecting paths.

Surface layers of magnetic material such as Nickel or permalloy are formed or deposited on the substrate 101. These layers include the sections 102′ and 102″ on the top surface. On the lower surface, additional magnetic tracks 105 and 106 are formed with an air gap 122 therebetween. Plated-through holes 111′ and 111″ are formed, e.g., by drilling through the sections 102′ and 102″, the PCB 101, and the lower sections 105 and 106, and plating the holes with nickel or other material having suitable magnetic or magnetic and electrical characteristics.

To plate the holes, the inside of the through holes is seeded with a conductive surface (not shown), eg, by chemical deposition through a mask, and the magnetic material is then deposited by electrolysis, forming plated through holes, 111′ and 111″, to connect the upper and lower portions of the magnetic path.

In FIG. 4A, the magnetic surface layers and magnetic paths in the through holes are depicted as being made entirely of magnetic material. In an alternative embodiment the surface layers and through holes are first fabricated in copper using a conventional PCB process and the magnetic material is then deposited over the copper as a separate layer.

FIG. 4B shows the next stage in which a removable layer 112 has been applied over the top surface. Preferably the removable layer is attached to the assembly by an adhesive, 115, which may also serve as a filler. This may be done by applying the adhesive as a separate layer or, preferably as a laminate combined with the removable layer 112. The adhesive/filler may be designed to be removed or it may be designed to be left in place. If it is to be left in place, the process of applying the removable layer should be controlled to ensure that the adhesive does not contaminate areas intended as electrical contact points. This may be achieved, e.g., by maintaining a high rolling force in the case where the upper layer, 112, is applied by a rolling process. Alternatively, the removable layer, 112 and the filler layer may be formed integrally of the same removable material.

FIG. 4C shows a subsequent phase where a cantilever armature 113 has been formed on the layer 112. The “free” end of the armature is thickened at 114 with ferro-magnetic material. The purpose for the thickening will now be explained. The force needed to bend the armature depends on the cross section of the armature. The bending force in the vertical direction is influenced by the thickness (the vertical dimension of the beam) so the armature needs to be made thin to reduce the required force and hence the operating current. However the trade off for reducing the cross section is that the magnetic saturation of the beam is related to the cross section. When the beam is sufficiently thin to operate at a suitable trip current, we have found that the beam tends to saturate before it can be fully tripped. This means that, once the beam saturates, increases in operating current have little effect in producing further bending of the beam. To overcome this problem, we have included an additional magnetic “shunt” path 102″, which is thicker than the beam, 113 and the magnetic flux follows the path of least reluctance along 102″ towards its free end. The free end of 102″ is proximate to the thickened end 114 of beam 113, and is designed not to saturate at the tripping current. The reluctance of the path from the end of magnetic shunt 102″, the air gap to beam end 114, beam end 114, and the air gap between beam end 114 and contact pad 102′, should be less than the reluctance between 102″ and 102′ to ensure most of the flux is harnessed to operate the armature. The magnetic flux thus finds the thickened end 114 to be the path of least reluctance and thus it is directed towards the contact pad formed by 102′.

As the armature is formed on the removable layer, 112, it is necessary to connect the armature to the rest of the assembly in advance of the removal of the layer 112. To do this, a hole is drilled through the armature 113 and the removable layer 112 to link with the plated-through hole, 111″. A conductive seed layer is then applied through a mask to coat the inside of the plated-through hole 111″ with a conductive seed layer of, e.g., copper. Preferably, the mask also permits deposition of the conductive seed layer on a section of the top of the armature to facilitate establishing electrical contact to the seed layer. The seed layer is then used as an electrode for an electroplating process to build up an additional “post” or “rivet”, 116, of magnetic/conductive material projecting above the layer 102″ and connected to the armature 113. The “rivet” is built up to a thickness sufficient to support the armature under “load”.

Optionally, the removable layer (release layer) 112 can be left in place if the semi-completed arrays are to be stored or transported prior to the final packaging step.

In an alternative embodiment of the invention, the plated-through holes 111′ and 111″ are formed at the same time as the “rivet”. In this embodiment, the holes for both through-holes are drilled after the removable layer 112 has been applied, and seed layers are chemically deposited through both holes and the electrolytic deposition of both plated-through linings is performed at the same time.

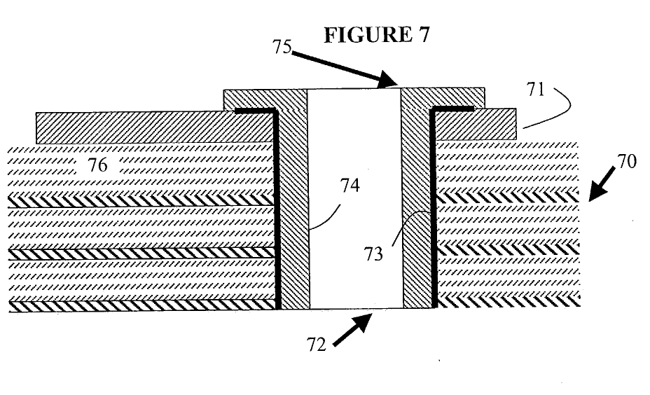

FIG. 7 shows details of a plated through hole. The multi-layer PCB 70 has a layer of magnetic material, 71, deposited on a release layer 76. Layer 71 is, e.g., the armature. A hole, 72 is drilled through the PCB and the layer 71. A conductive seed layer 73 is deposited through a mask onto the inside of the hole. The mask may permit the conductive layer to fold over on the top surface. Once the seed layer is formed, the assembly is placed in an electrolysis bath and the magnetic layer, 74, is deposited through the mask. The deposit forms a hollow “rivet”, 75, which is attached to the armature 71, and holds it firmly in place as the rivet head and part of the stem of the rivet are bonded with the armature, having been electroplated onto the armature.

FIG. 4D shows the relay with the release layer 112 and the mask 115 removed. The removal of the release layer 112 frees up the armature 113.

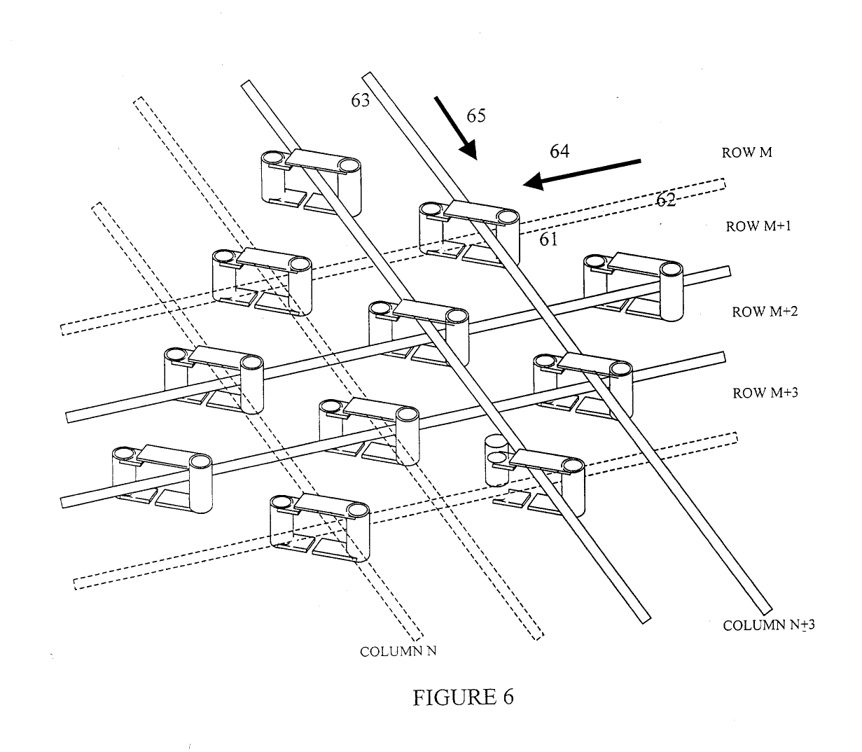

As shown in FIG. 6, an array of relays, 61, are located at the intersection of row conductors, 62, and column conductors, 63. For the sake of clarity, the relays are shown only at alternate intersections, but, in practice, there could be a relay at each intersection. Thus, when row 62 and column 63 are energised with currents which add (ie enter or approach the magnetic path from the same side as shown by arrows 64, 65), and providing the currents add to more than the trip current, the relay 61 will be operated. Provided that the individual currents in the row and column are less than the trip current, none of the other relays will operate. Where the relays are fitted with latching magnets, an operating current producing a magnetic field in the same direction as the field from the latching magnet across the contact gap will operate the relay and the latching magnet will hold it in the closed position. In order to unlatch the relay, the currents should be applied in the opposite sense to produce a magnetic field opposing the field from the latching magnet.

The electrical arrangement adapted for switching a pair of conductors is shown in FIG. 5 which represents an array of relays. A pair of relays, 51, 55, are arranged to connect the input pair 1 to the output pair 2. Input pair 1 includes lines 53 and 57, and output pair 2 includes lines 52 and 56. Relay 51 connects line 53 to line 52, and relay 55 connects line 57 to line 56. Relay 51 is activated by Row Drive 1A and Column Drive 4A, and relay 55 is activated by Row drive 1A and Column Drive 3A. Thus, the relays of the pair can be operated simultaneously or independently, eg, to provide a “make-before-break” operation.

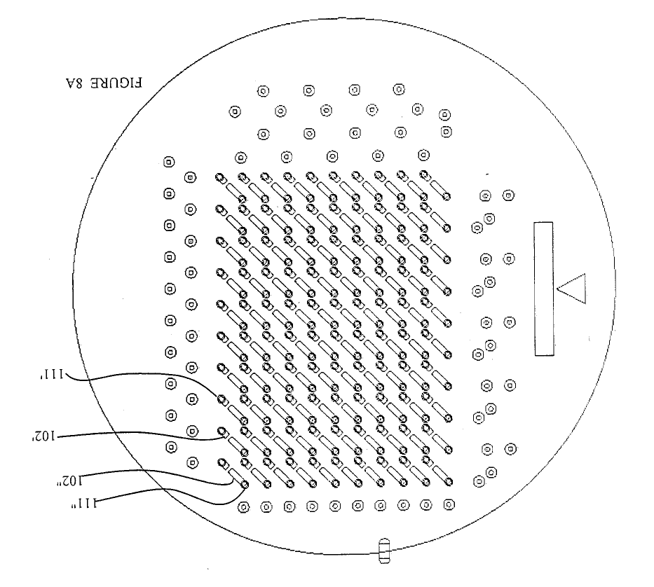

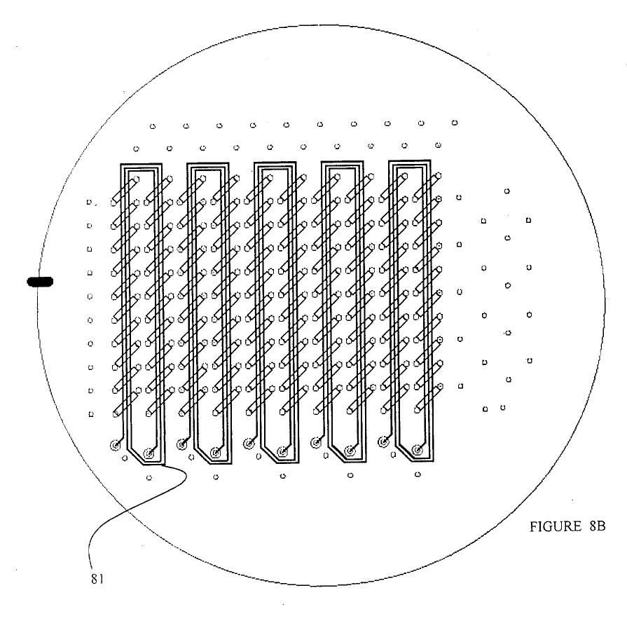

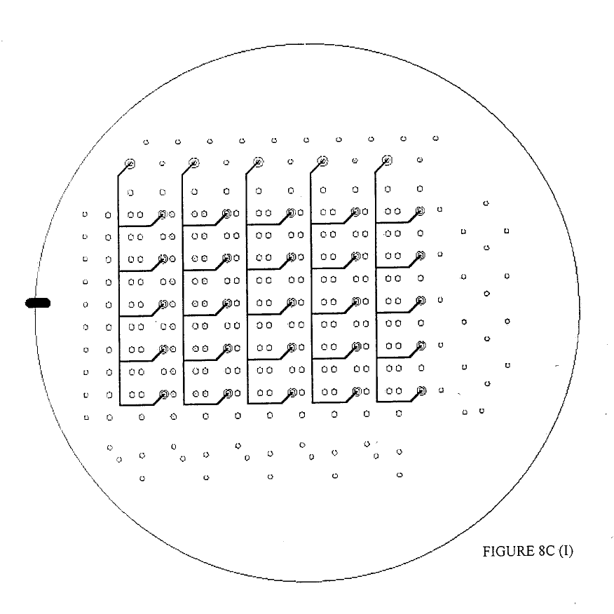

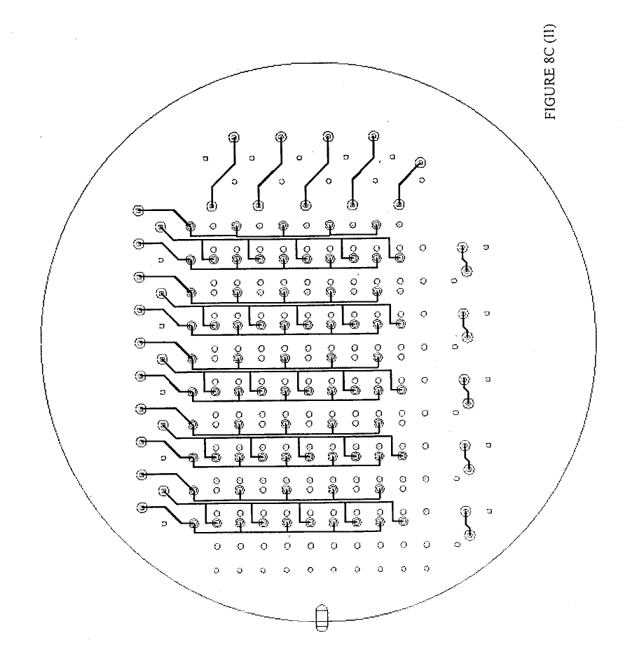

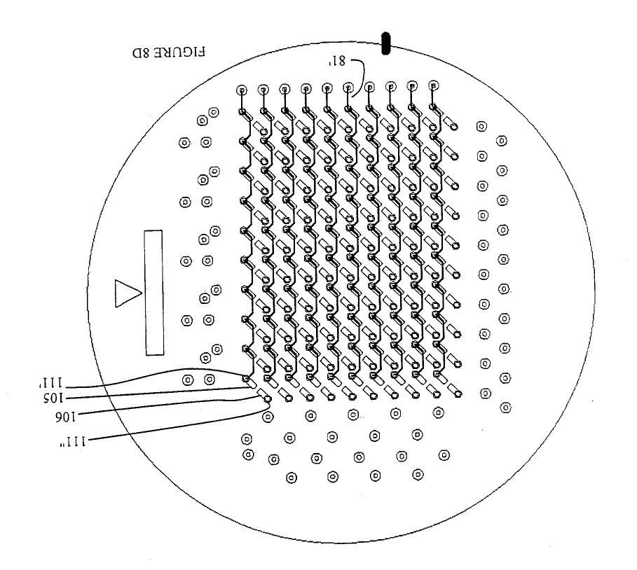

FIGS. 8A to 8D are illustrative of layers of which a PCB arrangement implementing an embodiment of the invention can be built up.

FIG. 8A show the “top” layer of the PCB before the release layer and armatures have been applied. The array of fixed contacts 102′ and magnetic shunts 102″ and their associated through holes 111′ and 111″ can be see.

FIG. 8B illustrates an arrangement of one layer of activating conductor tracks, in this example formed into 5 loops.

To illustrate the relationship between the relay magnetic paths and the conductor tracks, a number of diagonal rectangles are shown on this drawing joining pairs of holes from which the plated-through holes are built up. However the diagonal “magnetic” elements do not form part of this layer, and are shown only to provide the context for the relationship between the activating tracks and the magnetic paths.

From FIG. 5B, it can be seen that an activating current in one loop will pass through a first column of relays in a first direction, and through the neighbouring second column in the opposite sense.

While the activating current paths are shown as loops, it should be understood that other configurations adapted to particular applications could be provided without departing from the spirit of the invention.

The loop driving current arrangement is suitable for applications where it is desired to operate relays in pairs. In particular, where both the row and column driving coils form such loops, relays can be operated in diagonally opposite pairs.

However, the driving current could also be applied to individual rows and columns by providing individual sets of row/column conductors, as illustrated in FIG. 5.

While it is possible to provide individual activating coils for each relay, the row/column addressing method provides and efficient method of obtaining a high density of relays.

As mentioned above, a corresponding layer of row driving coils can be applied either on the reverse side of the PCB core or on another layer. Two or more layers of row and column driving coils may be built up using a number of PCB layers.

FIG. 8C(I) and (II) illustrate signal conductor patterns for connecting the row signal conductors according to an embodiment of the invention.

FIG. 8D illustrates an arrangement for connecting the signal paths for all the relays in a column of relays in which one half of the “bottom” part of the magnetic/conductive relay elements are connected together. For example the “side” of the relay connected to the armature, 106, 111″, of each relay in a column are connected together.

The other half of the relay including 105 and plated through holes 111′ are connected as now signal lines.

The arrangement shown in FIG. 5 can be equated to the arrangement shown in FIG. 8B by connecting the terminal “Column Drive 1A” to the terminal “Column Drive 2A” so that the current flows from “Column Drive 1B” to “Column Drive 2B”, that is, the current flows “up” the left side of the pair and “down” the right side of the pair.

The row drives in FIG. 5 can similarly be paired, so that relays can be operated in diagonal pairs in a simple manner.

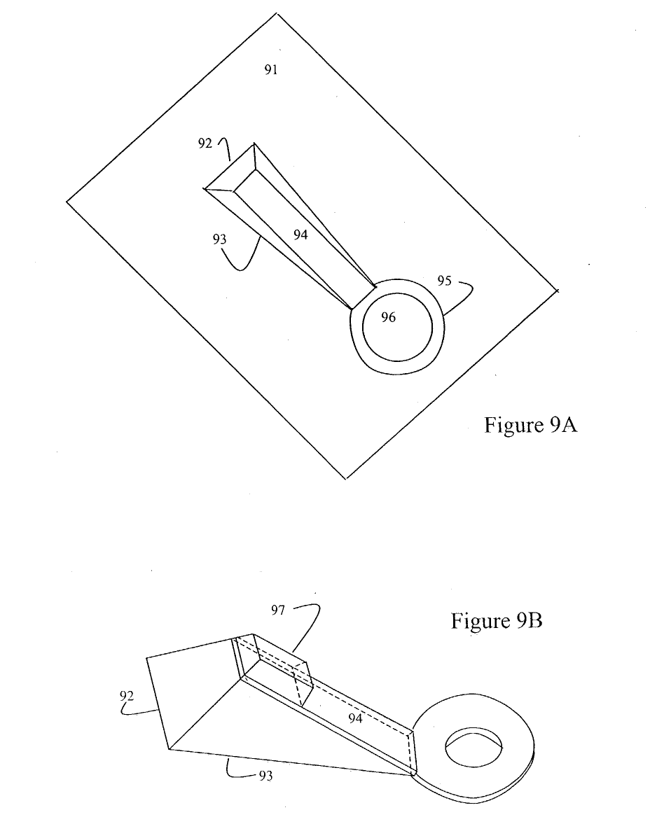

FIG. 9A shows an element including a base release layer 91 with a pyramid like profile embossed on it. The embossing has a short front edge, 92 and a long side edge 93, which rise steeply to a sloping top plane on which an armature, 94, is formed. The armature is formed of resilient magnetic material which-may be conductive and/or of the same material as the other parts of the magnetic circuit. An insoluble connection portion, 95, is formed at the base of armature, 94. Again, the connection portion is preferably magnetic and may also be conductive. A hole, 96, is provided through the connection portion, 95, and the release layer, 91, to permit connection to the underlying assembly, eg, as shown in FIG. 4B.

FIG. 9B shows detail of the armature, 94, with a thickened end, 95. A sheet including an array of embossed armatures located to correspond with the position of the associated relay magnetic circuits can thus be applied to the top of the PCB rather than forming the armatures in situ.

The sheet can then be affixed, eg, by a suitable adhesive.

Base PCB Fabrication Including Magnetic Pathways:

The fabrication of the switching array starts with the fabrication of the base PCB part. There are many variations of PCB manufacturing processes known in the art. The present invention may be fabricated using a base PCB made with any of these processes. The following description is provided as an example of a typical process.

The manufacture of a multilayer PCB typically involves the fabrication of a number of thin 2 layer PCBs called “cores” which are typically laminated together with layers of partially cured epoxy-glass fibre composite called “prepreg”. The stack of 2 layer cores and interposed prepreg layers is typically placed in a press where pressure and heat is applied to cure the prepreg layers.

The tracks on either side of the 2 layer cores may be formed in a number of different ways. In the most common method (known as the subtractive method) copper foil initially covers both sides of the core and is then selectively etched away using a mask to define the tracking patterns. Alternatively an additive process may be used where tracks are plated up from a blank fibreglass core after seeding with conductive material. Combinations of subtractive and additive processing are also common. In additive processing techniques the top and bottom layers are sometimes made of prepreg to reduce the number of cores required. Examples of tracks formed on the cores are shown in FIG. 8.

After pressing/curing is completed the partially complete assembly is drilled in positions corresponding to plated through holes. The holes are then seeded with a thin layer of conductive material. Seeding may typically be via an electroless copper or nickel process, vacuum copper deposition or deposition of carbon. Optionally the thickness of copper in the plated though holes may be built up be electroplating prior to plating of magnetic material in the holes. This additional build up of copper has the advantage of improving the electrical conductivity of the plated-through holes where it is intended to use the through-hole plating as part of the electrical signal path.

In order to realize the desired magnetic properties of the present invention, magnetic material is electroplated in the plated through holes and onto some of the tracking layers (typically the outer two layers). The electroplated magnetic material is typically nickel or permalloy (an alloy of nickel and iron). The magnetic material is typically over-plated on a base of copper formed for example as described above. A layer of gold is then typically applied over the magnetic material for corrosion protection and to improve conductivity in the contact areas. The present design may typically be fabricated with 8 layers in the base PCB. Of these layers, two inner layers are typically allocated to row coils and two inner layers to column coils (eg, FIG. 8B). The top and bottom (outside) layers (FIGS. 8A & 8D) are typically allocated to magnetic pole pieces and some contact connections. In FIG. 8D, the column signal conductors, 81, are shown connected to corresponding plated through holes, 111″. The remaining contact connections are typically allocated to the two remaining inner layers, FIGS. 8C(I) & (II). More or less layers may be used depending on factors such as the required number of coil turns and the desired contact wiring complexity.

FIGS. 8A to 8D show example tracking patters for the 8 layers.

Cantilever Beams Fabrication

According to an embodiment of the present invention the cantilever beams may be fabricated and attached to the base PCB using a number of alternative methods. These methods may be subdivided into two categories: 1. in-place methods and 2. separate fabrication methods.

In-place fabrication method will be described with particular reference to FIG. 4.

In this method of manufacture the base PCB is covered with a removable layer as shown at 112 in FIG. 4B. The layer 112 has the desired standoff height and the beams, 113, are formed on top of the removable layer. In this embodiment the removable layer is typically dissolved after the beams are formed. The removable layer may typically be plastic, metal, resist or photoresist material. The solvent type depends on the removable layer type being used and may be for example an acid solution, an alkali solution or a solvent such as acetone.

The removable layer may also be removed with non-liquid processing such as reactive-ion etching or vapour phase solvent.

The cantilever beams layer, 113, may typically be formed by electroplating on top of the removable layer using a mask to define the require beams shape. In the case of non-conducting removable layer a conducting seed layer would typically be first applied to the removable layer.

The beams may be attached to the base PCB in a number of different ways:

by forming holes in the removable layer and then plating through these holes at the same time as the beams are plated. The through plating in the removable layer plates onto corresponding plated through holes in the base PCB.

by forming holes in the removable layer; filling these holes with a support material and then plating the beam ends on top of the support material. The support material may typically be electroplated metal plated onto metal areas on top of the base PCB.

by forming holes in the removable layer; plating the beams on the removable layer; and then plating “rivets”, 116, to attach the beams to plated though holes in the base PCB. A separate mask is used to define the rivet heads.

The holes may be formed by techniques such as etching, drilling or photo-patterning (in the case the removable layer is photo-resist).

The underside of the beams is typically plated with gold to improve the electrical contact at the tip. This plating is achieved by plating the gold onto the removable layer/seed layer using the beams pattern mask before the beams are plated.

In an alternative embodiment a foil layer may be applied to the removable layer, forming attachments at the desired locations and then etching to form the beams. Attachment may be by riveting process as described above.

In a separate fabrication method, the beams may be fabricated separately and then applied to the base PCB in a later step of the manufacturing process.

For example in one embodiment the beams are electroplated onto a metal sheet using a mask pattern to define the required shape. The masking and plating steps may be repeated to produce beam features such as thickened tips or tips of a second material. The metal sheet also acts as the removable layer and may typically be aluminium or zinc. When aluminium is used, the metal is normally treated with a “zincate” process to allow subsequent electroplating.

After fabrication of the beams on the metal sheet the sheet is attached to the completed base PCB using an adhesive layer. Holes are then drilled through the sheet in the required attachment positions and electoplated “rivets” are used to attach the beams to corresponding plated through holes in the base PCB. Masks are used on the top of the metal layer and bottom of the PCB to confine plating to the rivet heads and body of the rivets inside the holes.

In one embodiment the adhesive layer is prepreg and is predrilled with clearance holes in the contact areas.

In this case the adhesive layer is permanent and remains after removal of the removable layer.

In an alternative embodiment of the separate fabrication method a foil layer may be applied to the removable layer and etched to form the beams. Attachment may then be made by the drilling and riveting process as described above.

In a further variation of the pre-fabrication process illustrated in FIG. 9, the beams are formed on the release sheet and the sheet is embossed to impose a geometric shape on the beam. The embodiment shown in FIG. 9 gives the beam a sloping orientation in relation to the surface of the PCB.

Packaging

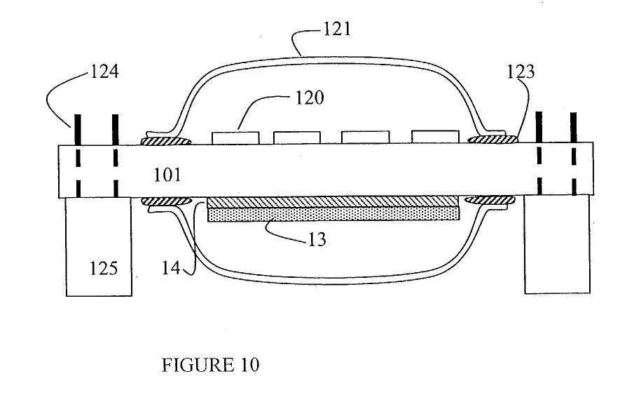

FIG. 10 shows a method of packaging an array of relays 120 formed integrally with a PCB 101. A domed cap, 121, formed, for example of steel, is glued to the upper surface of the PCB by a substantially air-tight peripheral ring of glue, 123. The gluing is carried out in an atmosphere which will not react adversely with the relays, eg, dry nitrogen, to reduce the exposure of the relays to moisture. A similar cap is glued to the lower surface, encompassing the magnetic sheet, 13, containing the alternate N-S stripes aligned with the air-gaps in the magnetic loops of the relay array.

One or more connectors, 125, are attached to the PCB, 101. The connector may have an array of press-fit connector pins, 124, passing through holes in the PCB to enable electrical connection to the driving coils and the signal paths.

Alternative encapsulation techniques are also envisaged by the invention. For example, a spacer element may be formed on or applied to the top of the assembly of relays in the array, the spacer element having a grid pattern forming individual recesses around each of the relays. The spacer should not contact the movable part of the armature. The depth of the spacer should be greater than the height of the relays above the PCB surface. An air-tight lid, sealed at least around the periphery of the spacer, can then be applied to isolate the relays from the atmosphere. It is not necessary that the individual cells be sealed, however the walls of the cells prevent the lid from sagging onto the armatures.

Flexible Bias Magnet

In a further embodiment, the armature may incorporate a bias magnet at its contact end, or may be composed of a flexible permanent magnet material. The use of a permanent magnet in proximity to the end of the armature enables a positive force to be exerted when opening the contacts by the reverse operating current.

1. A method for fabricating a relay integral with a substrate, the relay including a magnetic path, one or more activating current paths, and a switched path including the relay contacts, comprising the steps of:
forming the activating current path or paths on or within the substrate,
providing a first via or through-hole extending at least partly through the substrate,
forming at least a first magnetic through link in the via or through hole in the substrate from a first surface thereof and proximate to the activating current path or paths so that the first magnetic link is within the influence of magnetic flux from the current paths,
forming a first contact having both ferro-magnetic characteristics and electrical conductivity on or near a first surface of the substrate,
providing a second contact having both ferro-magnetic characteristics and electrical conductivity on or near the surface of the substrate, at least one of the first or the second contacts being movable relative to the other contact to selectively make or break electrical contact,
the first contact being in magnetic association with the first magnetic through link.

2. A method as claimed in claim 1, wherein the first contact is connected to the first magnetic through link, and is fixed on the surface of the substrate, and wherein the second contact is formed as an armature attached to the substrate and having a section movable in relation to the first contact.

3. A method as claimed in claim 2, wherein the second contact is formed as a cantilever or having a torsion support, or having a number of spiral spring supports supporting the second contact spaced from the surface of the substrate.

4. A method as claimed in claim 1, wherein by forming a second magnetic through link in a second via or through-hole proximate to the activating current path or paths so that the second magnetic link is within the influence of magnetic flux from the current paths in a sense opposite to the influence on the first magnetic through link, the second contact being attached to the second magnetic through link.

5. A method as claimed in claim 4, wherein by forming at least a first magnetic bridging link on a second side of the substrate opposite to the first side and connecting the first and second magnetic through links.

6. A method as claimed in claim 5, wherein by forming an air gap in the bridging link.

7. A method as claimed in claim 1, wherein by forming the second contact on a removable release layer removed before installing the relay in an operating environment.

8. A method as claimed in claim 4, wherein by forming a magnetic shunt on the first surface, the shunt forming part of the magnetic path from the second magnetic through-link via a shunt air gap to the first contact.

9. A method of forming a mechanical attachment to attach a relay element to a substrate, comprising the steps of:
forming the element or applying the element in proximity to the substrate,
forming an attachment hole through the element and the substrate,
masking the element and substrate to leave the attachment hole exposed,
seeding the attachment hole by deposition of a conductive layer therein and
electroplating the attachment hole to build up an attachment element in intimate contact with the element and the substrate.

10. A method as claimed in claim 9, characterized by forming the element over a plated-through hole in the substrate and aligning the attachment hole with the plated-through hole.

11. A method as claimed in claim 9, characterized by forming the element on a removable release layer applied to a surface of the substrate, and forming the attachment hole through the release layer.

12. A method as claimed in claim 9, wherein the masking leaves an exposed area around the rim of the attachment hole, and building up the attachment element on the exposed area.

13. A method for forming a mechanical attachment to attach a relay element to a substrate, comprising the steps of:
forming a plated-through hole in the substrate,
applying a removable release layer over the substrate,
forming an attachment hole in the release layer to expose the plated-through hole,
filling the attachment hole with a support material in contact with, and attached to the plated-through hole and
forming the relay element in contact with, and attached to the support material.

14 A method of forming a mechanical attachment between a relay element and a substrate, comprising the steps of:
forming a plated-through hole in the substrate in the substrate;
applying a removable release layer to a surface of the substrate;
forming an attachment hole in the release layer;
plating the element onto the release layer, the element being formed in contact with and attached to the plated-through hole through the attachment hole.

15 A method of forming a relay array, individual relays fabricated according to method of claim 1, wherein the individual relays are aligned in rows and columns, arranging the activating conductors of each row to pass through the magnetic loop of each relay in the row and arranging the activating conductors of each column to pass through the magnetic loop of each relay in the column.

16 A method of forming a relay array as claimed in claim 15, characteriszed by applying a magnetic sheet having alternate permanent magnetic strips of north and south poles aligned with the air-gaps of the rows or columns of relays.

17 A method of fabricating an array of miniature relays, comprising the steps of:
forming a base PCB containing one of more layers of activating conductors, first contact parts, and contact connection conductors,
forming or attaching a dissolvable layer on one side of the said base PCB,
forming or placing preformed second contact parts on said dissolvable layer said second contact parts incorporating a flexible section with attachment means to said base PCB and
removing said dissolvable layer.

18 A method as claimed in claim 17 wherein magnetic pathways are included the base PCB.

19 A method as claimed in claim 17 wherein a bias magnet means is placed on the opposite side of said base PCB to said contact parts.
